(19) United States
(12) Patent Application Publication
(10) Pub. No.: US 2019/0106628 A1
(43) Pub. Date: Apr. 11, 2019

(54) METHOD FOR PREPARING LIQUID CRYSTAL ALIGNMENT LAYER

(71) Applicant: LG CHEM, LTD., Seoul (KR)

(72) Inventors: Hyeong Seuk YUN, Daejeon (KR); Soon Ho KWON, Daejeon (KR); Hee HAN, Daejeon (KR); Jung Ho JO, Daejeon (KR); Hang Ah PARK, Daejeon (KR); Jun Young YOON, Daejeon (KR)

(73) Assignee: LG CHEM, LTD., Seoul (KR)

(21) Appl. No.: 16/087,591

(22) PCT Filed: Apr. 25, 2017
(86) PCT No.: PCT/KR2017/004377

§ 371 Date: Sep. 21, 2018

(30) Foreign Application Priority Data
Aug. 19, 2016 (KR) 10-2016-0105509

(51) Int. Cl. C09K 19/56; C09D 177/06; C09D 177/10; G02F 1/1337

(52) U.S. Cl. CPC C09K 19/56; C09D 177/06; G02F 1/133723; G02F 1/133788; C09D 177/10

(57) ABSTRACT

The present invention provides a method for preparing a liquid crystal alignment layer having excellent alignment properties and stability as well as enhanced electrical characteristics such as voltage holding ratio. The present invention also provides a liquid crystal alignment layer prepared by the preparation method above and a liquid crystal display device comprising the liquid crystal alignment layer thus prepared.

### CROSS-REFERENCE TO RELATED APPLICATION(S)

This application claims the benefit of priority based on Korean Patent Application No. 10-2016-0105509 filed on Aug. 19, 2016 with the Korean Intellectual Property Office, the disclosure of which is incorporated herein by reference in its entirety.

### TECHNICAL FIELD

The present invention relates to a method for preparing a liquid crystal alignment layer having excellent alignment properties and stability as well as enhanced electrical characteristics such as voltage holding ratio.

### BACKGROUND ART

In a liquid crystal display device, a liquid crystal alignment layer plays a role of aligning liquid crystals in a certain direction. Specifically, a liquid crystal alignment layer serves as a director in the arrangement of liquid crystal molecules, and thus, when the liquid crystals move by the electric field to form an image, it helps to take an appropriate direction. Generally, in order to obtain uniform brightness and a high contrast ratio in a liquid crystal display device, it is essential that the liquid crystals are uniformly aligned.

As a conventional method for aligning a liquid crystal, a rubbing method of coating a polymer film such as polyimide onto a substrate such as glass and rubbing the surface thereof in a predetermined direction using fibers such as nylon or polyester has been used. However, the rubbing method may cause serious problems during manufacturing a liquid crystal panel because fine dust or electrostatic discharge (ESD) occurs when the fiber and polymer film are rubbed.

In order to solve the problems of the rubbing method, a photo-alignment method for inducing anisotropy in a polymer film by light irradiation rather than the rubbing, and aligning liquid crystals using the anisotropy has been studied recently.

As materials that can be used for the photo-alignment method, various materials have been introduced, among which polyimide is mainly used for various superior performance of a liquid crystal alignment layer. However, polyimide is usually poor in solubility in a solvent, and so it is difficult to apply it directly to a manufacturing process for forming an alignment layer by coating in a solution state. Accordingly, after coating in the form of a precursor such as a polyamic acid or a polyamic acid ester having excellent solubility, a high-temperature heat treatment process is performed to form polyimide, when is then subjected to light irradiation to align liquid crystals. However, as a large amount of energy is required for obtaining sufficient liquid crystal alignment properties by subjecting the layer in the form of polyimide to light irradiation, it is difficult to secure substantial productivity, and additionally, there is a limitation that an additional heat treatment process is required for securing alignment stability after the light irradiation.

### DETAILED DESCRIPTION OF THE INVENTION

### Technical Problem

It is one object of the present invention to provide a method for preparing a liquid crystal alignment layer having excellent alignment properties and stability as well as enhanced electrical characteristics such as voltage holding ratio.

It is another object of the present invention to provide a liquid crystal alignment layer prepared by the preparation method above and a liquid crystal display device comprising the same.

### Technical Solution

In order to overcome the objects above, the present invention provides a method for preparing a liquid crystal alignment layer comprising the steps of: 1) coating a liquid crystal aligning agent composition onto a substrate to form a coating film; 2) drying the coating film; 3) irradiating the coating film with light immediately after the drying step to perform alignment treatment; 4) subjecting the alignment-treated coating film to a low-temperature heat-treatment at 200° C. or lower; and 5) curing the heat-treated coating film by heat treatment at a temperature higher than that of the low-temperature heat treatment,

wherein the liquid crystal aligning agent composition comprises i) a first polymer for a liquid crystal aligning agent comprising two or more repeating units selected from the group consisting of a repeating unit represented by Chemical Formula 1 below, a repeating unit represented by Chemical Formula 2 below, and a repeating unit represented by Chemical Formula 3 below, wherein the repeating unit represented by Chemical Formula 1 below is contained in an amount of 5 to 74 mol % relative to the total repeating units represented by Chemical Formulae 1 to 3 below, ii) a second polymer for a liquid crystal aligning agent comprising a repeating unit represented by Chemical Formula 4 below, and iii) a compound having two or more epoxy groups in a molecule:

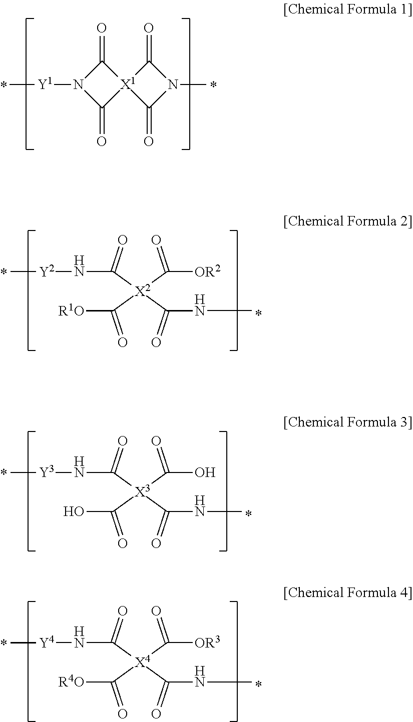

### in Chemical Formulae 1 to 4,

R¹ and R² are each independently hydrogen, or C₁₋₁₀ alkyl, with the proviso that R¹ and R² cannot both be hydrogen,

R³ and R⁴ are each independently hydrogen, or C₁₋₁₀ alkyl, and

X¹ is a tetravalent organic group represented by Chemical Formula 5 below,

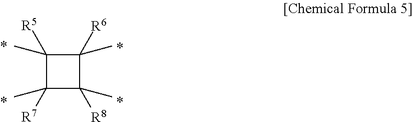

### in Chemical Formula 5,

R⁵ to R⁸ are each independently hydrogen, or C₁₋₆ alkyl,

X², X³ and X⁴ are each independently a tetravalent organic group derived from a hydrocarbon having 4 to 20 carbon atoms, or a tetravalent organic group in which at least one hydrogen of the tetravalent organic group is substituted with a halogen or at least one —CH₂— is replaced by —O—, —CO—, —S—, —SO—, —SO₂—, or —CONH— such that oxygen or sulfur atoms are not directly linked, and

Y¹, Y², Y³ and Y⁴ are each independently a divalent organic group represented by Chemical Formula 6 below,

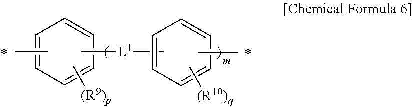

### in Chemical Formula 6,

R⁹ and R¹⁰ are each independently halogen, cyano, C₁₋₁₀ alkyl, C₂₋₁₀ alkenyl, C₁₋₁₀ alkoxy, C₁₋₁₀ fluoroalkyl, or C₁₋₁₀ fluoroalkoxy,

p and q are each independently an integer between 0 and 4,

L¹ is a single bond, —O—, —CO—, —S—, —SO₂—, —C(CH₃)₂—, —C(CF₃)₂—, —CONH—, —COO—, —(CH₂)_{z}—, —O(CH₂)_{z}O—, —O(CH₂)_{z}—, —OCH₂—C(CH₃)₂—CH₂O—, —COO—(CH₂)_{z}—OCO—, or —OCO—(CH₂)_{z}—COO—,

wherein z is an integer between 1 and 10, and

m is an integer between 0 and 3.

In addition, the present invention provides a method for preparing a liquid crystal alignment layer comprising the steps of: 1) coating a liquid crystal aligning agent composition onto a substrate to form a coating film; 2) drying the coating film; 3) irradiating the coating film with light immediately after the drying step to perform alignment treatment; 4) subjecting the alignment-treated coating film to a low-temperature heat-treatment at 200° C. or lower; and 5) curing the heat-treated coating film by heat treatment at a temperature higher than that of the low-temperature heat treatment,

wherein the liquid crystal aligning agent composition comprises a polyimide precursor and a compound having two or more epoxy groups in a molecule.

The method for preparing a liquid crystal alignment layer according to the present invention uses a liquid crystal aligning agent composition comprising a polyimide precursor and a compound having two or more epoxy groups in a molecule, or a liquid crystal aligning agent composition comprising a compound having two or more epoxy groups together with a first polymer for a liquid crystal aligning agent and a second polymer for a liquid crystal aligning agent, which are partially imidized polyimide precursors.

Generally, it is known that when an epoxy material is contained in a liquid crystal aligning agent, the strength and high voltage holding ratio of an alignment layer are enhanced, and that the degree thereof increases as the content of the epoxy material increases. However, when the content of the epoxy material increases, there is a problem that the high-temperature AC brightness fluctuation rate of a liquid crystal cell increases. The reason why the high-temperature AC brightness fluctuation characteristics are deteriorated is not theoretically limited, but it is attributed to the fact that the alignment of the liquid crystal aligning agent and the epoxy reaction are carried out simultaneously as the alignment of the liquid crystal aligning agent is carried out at a high temperature.

Accordingly, in an embodiment of the present invention, a liquid crystal aligning agent composition according to the present invention is coated onto a substrate and dried, and then directly irradiated with linearly polarized light without an imidization process, to induce initial anisotropy, and then, a part of the alignment layer is reoriented through a low-temperature heat treatment to stabilize decomposition products. Subsequently, while performing a high-temperature heat treatment at a temperature higher than that of the low-temperature heat treatment to progress the imidization, the alignment stabilization by the epoxy reaction can be achieved at the same time. Accordingly, there are advantages in that as the initial anisotropy progresses without an epoxy reaction, the content of the epoxy material can be increased while the alignment is effectively performed.

The liquid crystal alignment layer prepared according to the method for preparing a liquid crystal alignment layer as described above is characterized by not only exhibiting excellent alignment properties, but also exhibiting an excellent high-temperature AC brightness fluctuation ratio and maintaining a high voltage holding ratio for a long time.

Hereinafter, the present invention will be described in detail for each step.

### Definition of Terms

Unless specified otherwise herein, the following terms can be defined as follows.

The C₄₋₂₀ hydrocarbon may be C₄₋₂₀ alkane, C₄₋₂₀ alkene, C₄₋₂₀ alkyne, C₄₋₂₀ cycloalkane, C₄₋₂₀ cycloalkene, C₄₋₂₀ arene, or a fused ring in which at least one of the cyclic hydrocarbons shares two or more atoms, or a hydrocarbon to which at least one of the hydrogens is chemically bonded. Specifically, examples of C₄₋₂₀ hydrocarbon may include n-butane, cyclobutane, 1-methylcyclobutane, 1,3-dimethylcyclobutane, 1,2,3,4-tetramethylcyclobutane, cyclopentane, cyclohexane, cycloheptane, cyclooctane, cyclohexane, 1-methyl-3-ethylcyclohexene, bicyclohexyl, benzene, biphenyl, diphenylmethane, 2,2-diphenylpropane, 1-ethyl-1,2,3,4-tetrahydronaphthalene or 1,6-diphenylhexane, etc.

The C₁₋₁₀ alkyl group may be a straight-chain, branched-chain or cyclic alkyl group. Specifically, the C₁₋₁₀ alkyl group may be a straight-chain C₁₋₁₀ alkyl group; a straight-chain C₁₋₅ alkyl group; a branched-chain or cyclic C₃₋₁₀ alkyl group; or a branched-chain or cyclic C₃₋₆ alkyl group. More specifically, examples of the C₁₋₁₀ alkyl group may include a methyl group, an ethyl group, a n-propyl group, an iso-propyl group, a n-butyl group, an iso-butyl group, a tert-butyl group, a n-pentyl group, an iso-pentyl group, a neo-pentyl group or a cyclohexyl group, etc.

The C₁₋₁₀ alkoxy group may be a straight-chain, branched-chain or cyclic alkoxy group. Specifically, the C₁₋₁₀ alkoxy group may be a straight-chain C₁₋₁₀ alkoxy group; a straight-chain C₁₋₅ alkoxy group; a branched-chain or cyclic C₃₋₁₀ alkoxy group; or a branched-chain or cyclic C₃₋₆ alkoxyl group. More specifically, examples of the C₁₋₁₀ alkoxy group may include a methoxy group, an ethoxy group, a n-propoxy group, an iso-propoxy group, a n-butoxy group, an iso-butoxy group, a tert-butoxy group, a n-pentoxy group, an iso-pentoxy group, a neo-pentoxy group or a cyclohexoxy group, etc.

The C₁₋₁₀ fluoroalkyl group may be a group in which at least one hydrogen in the C₁₋₁₀ alkyl group is substituted with fluorine, and the C₁₋₁₀ fluoroalkoxy group may be a group in which at least one hydrogen in the C₁₋₁₀ alkoxy group is substituted with fluorine.

The C₂₋₁₀ alkenyl group may be a straight-chain, branched-chain or cyclic alkenyl group. Specifically, the C₂₋₁₀ alkenyl group may be a straight-chain C₂₋₁₀ alkenyl group, a straight-chain C₂₋₅ alkenyl group, a branched-chain C₃₋₁₀ alkenyl group, a branched-chain C₃₋₆ alkenyl group, a cyclic C₅₋₁₀ alkenyl group or a cyclic C₆₋₈ alkenyl group. More specifically, examples of the C₂₋₁₀ alkenyl group may include an ethenyl group, a propenyl group, a butenyl group, a pentenyl group or a cyclohexenyl group, etc.

The halogen may be fluorine (F), chlorine (Cl), bromine (Br) or iodine (I).

The multivalent organic group derived from an arbitrary compound refers to a residue in which a plurality of hydrogen atoms bonded to the arbitrary compound are removed. In one example, a tetravalent organic group derived from cyclobutene refers to a residue in which any four hydrogen atoms bonded to cyclobutane are removed.

In the present disclosure, the notation ______* refers to a residue in which hydrogens at the relevant site are removed. For example, the notation

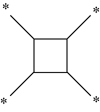

refers to a residue in which four hydrogen atoms bonded to carbon numbers 1, 2, 3 and 4 of cyclobutene are removed, that is, it refers to any one of tetravalent organic groups derived from cyclobutene.

### Coating a Liquid Crystal Aligning Agent Composition Onto a Substrate to Form a Coating Film (Step 1)

Step 1 is a step of coating a liquid crystal aligning agent composition onto a substrate to form a coating film.

The liquid crystal aligning agent composition comprises i) a first polymer for a liquid crystal aligning agent comprising two or more repeating units selected from the group consisting of a repeating unit represented by Chemical Formula 1, a repeating unit represented by Chemical Formula 2 and a repeating unit represented by Chemical Formula 3, wherein the repeating unit represented by Chemical Formula 1 is contained in an amount of 5 to 74 mol % relative to the total repeating units represented by Chemical Formulae 1 to 3, ii) a second polymer for a liquid crystal aligning agent comprising a repeating unit represented by Chemical Formula 4, and iii) a compound having two or more epoxy groups in a molecule.

When a conventional polyimide is used as a liquid crystal alignment layer, a polyimide precursor, a polyamic acid or a polyamic acid ester having excellent solubility is coated and dried to form a coating film, which is then converted to a polyimide through a heat treatment process at a high temperature, to which light irradiation is performed and alignment treatment is performed. However, as a large amount of energy is required for obtaining sufficient liquid crystal alignment properties by subjecting the layer in the form of polyimide to light irradiation, it is difficult to secure substantial productivity, and additionally, there is a limitation that an additional heat treatment process is undergone for securing alignment stability after the light irradiation. Since the large amount of light irradiation energy and the additional high-temperature heat treatment process are very disadvantageous in view of the cost of the process and process time, there existed a limitation in the application to a practical mass production process.

In this regard, the present inventors have found through experiments that, when the first polymer for a liquid crystal aligning agent which essentially comprises a repeating unit represented by Chemical Formula 1, and additionally comprises at least one selected from the group consisting of a repeating unit represented by Chemical Formula 2 and a repeating unit represented by Chemical Formula 3, and the second polymer for a liquid crystal aligning agent comprising a repeating unit represented by Chemical Formula 4 are mixed and used, the first polymer contains a certain amount of already imidized imide repeating units and thus, it is possible to produce anisotropy by directly irradiating the light without a heat treatment process after the formation of a coating film, followed by conducting a heat treatment to complete the alignment layer, and thus, not only the light irradiation energy can be significantly reduced, but also a liquid crystal alignment layer having excellent alignment properties and stability as well as excellent voltage holding ratio and electrical characteristics can be prepared.

The first polymer for a liquid crystal aligning agent may comprise the repeating unit represented by Chemical Formula 1, which is an imide repeating unit, in an amount of 10 to 74 mol % based on the total repeating units, among the repeating units represented by Chemical Formula 1, Chemical Formula 2 and Chemical Formula 3, preferably in an amount of 20 to 60 mol %. As described above, when the first polymer for a liquid crystal aligning agent which comprises a specific amount of the imide repeating unit represented by Chemical Formula 1 is used, the polymer comprises a certain amount of already imidized imide repeating units, and thus, a liquid crystal alignment layer having excellent alignment properties and stability as well as excellent voltage holding ratio and electrical characteristics can be prepared even when the high-temperature heat treatment process is omitted and light is directly irradiated. If the repeating unit represented by Chemical Formula 1 is included less than the content range, sufficient alignment properties may not be exhibited and alignment stability may be deteriorated. On the contrary, if the content of the repeating unit represented by Chemical Formula 1 exceeds the content range, the solubility is reduced, and thus it may be difficult to prepare a stable alignment solution capable of coating, which is problematic. Accordingly, it is preferable to comprise the repeating unit represented by Chemical Formula 1 within the above-mentioned content range, because it can provide a polymer for a liquid crystal aligning agent having excellent storage stability, electrical characteristics, alignment properties and alignment stability.

Further, the first polymer for a liquid crystal aligning agent may include the repeating unit represented by Chemical Formula 2 or the repeating unit represented by Chemical Formula 3 in an appropriate amount depending on the desired characteristics. Specifically, the repeating unit represented by Chemical Formula 2 may be included in an amount of 0 to 40 mol % based on the total repeating units represented by Chemical Formulae 1 to 3, preferably in an amount of 0 to 30 mol %. The repeating unit represented by Chemical Formula 2 has a low rate of conversion to imide during the high-temperature heat treatment process after the light irradiation, and thus if the above range is exceeded, the overall imidization rate is insufficient, thereby deteriorating the alignment stability. Accordingly, the repeating unit represented by Chemical Formula 2 exhibits an appropriate solubility within the above-mentioned range and thus can provide a polymer for a liquid crystal aligning agent which can implement a high imidization rate, while having excellent processing properties. Furthermore, the repeating unit represented by Chemical Formula 3 may be included in an amount of 0 to 95 mol % based on the total repeating units represented by Chemical Formulae 1 to 3, preferably in an amount of 10 to 90 mol %. Within such a range, excellent coating properties can be exhibited, thereby providing a polymer for a liquid crystal aligning agent which can implement a high imidization rate, while having excellent processing properties.

Meanwhile, the second polymer for a liquid crystal aligning agent is mixed with the first polymer for a liquid crystal aligning agent, which is a partially imidized polymer, and used as a liquid crystal aligning agent, and thus can significantly enhance the electrical characteristics of an alignment layer such as voltage holding ratio as compared to the case where only the first polymer for a liquid crystal aligning agent is used.

In order to exhibit such an effect, it is preferable that X⁴ in the repeating unit represented by Chemical Formula 4 is derived from an aromatic structure in view of improving the voltage holding ratio. In addition, in the repeating unit represented by Chemical Formula 4, it is preferable that Y⁴ is a bivalent organic group represented by Chemical Formula 6. Herein R⁹ and R¹⁰ are each independently a short-chain functional group having 3 or less carbon atoms, or it is more preferable that R⁹ and R¹⁰, which are branched structures, are not included (p and q are 0).

Preferably, the X², X³ and X⁴ are each independently a tetravalent organic group represented by the following Chemical Formula 7:

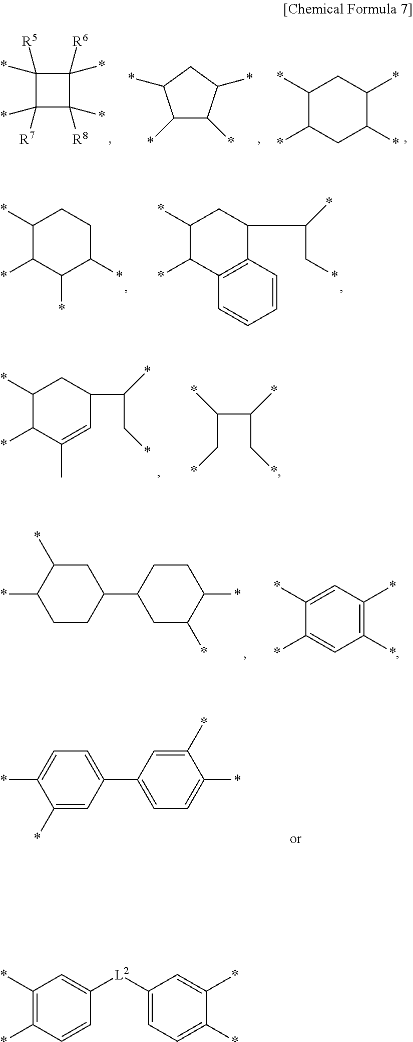

### in Chemical Formula 7,

R⁵ to R⁸ are each independently hydrogen, or C₁₋₆ alkyl,

L² is a single bond, —O—, —CO—, —S—, —C(CH₃)₂—, —C(CF₃)₂—, —CONH—, —COO—, —(CH₂)_{z}—, —O(CH₂)_{z}O—, or —COO—(CH₂)_{z}—OCO—,

wherein z is an integer between 1 to 10.

Further, the first polymer for a liquid crystal aligning agent and the second polymer for a liquid crystal aligning agent may be mixed in a weight ratio of about 15:85 to 85:15, preferably in a weight ratio of about 20:80 to 80:20. As described above, the first polymer for a liquid crystal aligning agent contains a certain amount of already imidized imide repeating units and thus, it is possible to produce anisotropy by directly irradiating the light without a heat treatment process at a high-temperature after the formation of the coating film, followed by conducting a heat treatment to complete the alignment layer. The second polymer for a liquid crystal aligning agent can enhance the electrical characteristics such as voltage holding rate. When the first polymer for a liquid crystal aligning agent and the second polymer for a liquid crystal aligning agent having such characteristics are mixed in the weight ratio range above and used, the excellent photo-reaction characteristics and liquid crystal alignment properties of the first polymer for a liquid crystal aligning agent and the excellent electrical characteristics of the second polymer for a liquid crystal aligning agent can be complemented with each other, and thus a liquid crystal alignment layer having excellent alignment properties and electrical characteristics simultaneously can be prepared.

In addition to the first polymer for a liquid crystal aligning agent and the second polymer for a liquid crystal aligning agent described above, the liquid crystal aligning agent composition according to the present invention comprises a compound having two or more epoxy groups in a molecule, thereby allowing a liquid crystal alignment layer prepared therefrom to exhibit a high voltage holding ratio.

The molecular weight of the compound having two or more epoxy groups in a molecule may preferably be from 100 to 10,000.

As the compound having two or more epoxy groups in a molecule, a cycloaliphatic-based epoxy, a bisphenol-based epoxy or a novolak-based epoxy may be used. Specific examples thereof include (3′,4′-epoxycyclohexane)methyl 3,4-epoxycyclohexylcarboxylate, 4,4′-methylenebis(N,N′-diglycidylaniline) or 2,2′-(3,3′,5,5′-tetramethylbiphenyl-4,4′-diyl)bis(oxy)bis(methylene)dioxirane.

Furthermore, the compound having two or more epoxy groups in a molecule is preferably included in an amount of 0.1 to 30% by weight based on the total weight of the first polymer for a liquid crystal aligning agent and the second polymer for a liquid crystal aligning agent.

Meanwhile, the method of coating the liquid crystal aligning agent composition onto a substrate is not particularly limited, and for example, a method such as screen printing, offset printing, flexographic printing, inkjet, and the like can be used.

Furthermore, the liquid crystal aligning agent composition may be a composition in which the first polymer for a liquid crystal aligning agent and the second polymer for a liquid crystal aligning agent are dissolved or dispersed in an organic solvent. Specific examples of the organic solvent include N,N-dimethylformamide, N,N-dimethylacetamide, N-methyl-2-pyrrolidone, N-methylcaprolactam, 2-pyrrolidone, N-ethylpyrrolidone, N-vinylpyrrolidone, dimethylsulfoxide, tetramethylurea, pyridine, dimethyl sulfone, hexamethyl sulfoxide, γ-butyrolactone, 3-methoxy-N,N-dimethylpropanamide, 3-ethoxy-N,N-dimethylpropanamide, 3-butoxy-N,N-dimethylpropanamide, 1,3-dimethyl-imidazolidinone, ethyl amyl ketone, methyl nonyl ketone, methyl ethyl ketone, methyl isoamyl ketone, methyl isopropyl ketone, cyclohexanone, ethylene carbonate, propylene carbonate, diglyme, 4-hydroxy-4-methyl-2-pentanone, ethylene glycol monomethyl ether, ethylene glycol monomethyl ether acetate, ethylene glycol monoethyl ether, ethylene glycol monoethyl ether acetate, ethylene glycol monopropyl ether, ethylene glycol monopropyl ether acetate, ethylene glycol monoisopropyl ether, ethylene glycol monoisopropyl ether acetate, ethylene glycol monobutyl ether, ethylene glycol monobutyl ether acetate and the like. They can be used alone or in combination of two or more.

In addition, the liquid crystal aligning agent composition may further comprise other components in addition to the polymer for a liquid crystal aligning agent and the organic solvent. In a non-limiting example, when the liquid crystal aligning agent composition is coated, an additive capable of improving the uniformity of the thickness of a layer and the surface smoothness, improving the adhesion between a photo-alignment layer and a substrate, changing the dielectric constant and conductivity of a photo-alignment layer or increasing the denseness of a photo-alignment layer, may further be included. Examples of such additives include various solvents, surfactants, silane-based compounds, dielectrics or crosslinking compounds, etc.

### Drying the Coating Film (Step 2)

Step 2 is a step of drying the coating film prepared in Step 1.

The step of drying the coating film is for removing solvent or the like used in the liquid crystal aligning agent composition, and for example, a method such as heating of a coating film or vacuum evaporation may be used. The drying may be preferably carried out at 50 to 130° C., more preferably at 70 to 120° C.

### Irradiating the Coating Film with Light Immediately After the Drying Step to Perform Alignment Treatment (Step 3)

Step 3 is a step of irradiating the coating film dried in Step 2 with light to perform alignment treatment.

In the present disclosure, the “coating film immediately after the drying step” refers to irradiating the light immediately after the drying step without carrying out a heat treatment at a temperature higher than that of the drying step, and other steps other than the heat treatment can be added.

More specifically, when a liquid crystal alignment layer is prepared using a conventional liquid crystal aligning agent comprising polyamic acid or polyamic acid ester, it comprises a step of irradiating light after essentially carrying out a high-temperature heat treatment for imidization of the polyamic acid. However, a liquid crystal alignment layer is prepared using the liquid crystal aligning agent of one embodiment described above, it does not comprise the heat treatment step, but light is directly irradiated to perform alignment treatment, and then the alignment-treated coating film is cured by a heat treatment, thereby preparing a liquid crystal alignment layer having sufficient alignment properties and improved stability even under a small amount of light irradiation energy.

In addition, in the alignment treatment step, the light irradiation is preferably performed by irradiating polarized ultraviolet rays having a wavelength of 150 to 450 nm. Herein, the intensity of the light exposure varies depending on the kind of the polymer for a liquid crystal aligning agent, and preferably an energy of 10 mJ/cm² to 10 J/cm², more preferably an energy of 30 mJ/cm² to 2 J/cm² may be irradiated.

As for the ultraviolet rays, the polarized ultraviolet rays selected from the ultraviolet rays subjected to polarization treatment through a method of penetrating or reflecting (1) a polarizing device using a substrate coated with a dielectric anisotropic material on the surface of a transparent substrate such as quartz glass, soda lime glass, soda lime free glass, etc., (2) a polarizer plate on which aluminum or metal wires are finely deposited, or (3) a Brewster's polarizing device by the reflection of quartz glass, etc., are irradiated to perform the alignment treatment. Herein, the polarized ultraviolet rays may be irradiated perpendicularly to the surface of the substrate, or may be irradiated by directing an angle of incidence toward a specific angle. By this method, the alignment ability of the liquid crystal molecules is imparted to the coating film.

### Subjecting the Alignment-Treated Coating Film to a Low-Temperature Heat-Treatment (Step 4)

Step 4 is a step of subjecting the coating film alignment-treated in Step 3 to a low-temperature heat treatment.

As described above, since the initial anisotropy was induced by directly irradiating linearly polarized light without an imidization process in Step 3, this is a step of reorienting a part of the alignment layer and stabilizing decomposition products through a low-temperature heat treatment. Further, such a low-temperature heat treatment step is distinguished from the step of curing the alignment-treated coating film by heat treatment to be described later.

The temperature for the low-temperature heat treatment is a temperature capable of reorienting a part of the alignment film and stabilizing decomposition products without curing the coating film, and is preferably 200° C. or lower. Preferably, the temperature for the low-temperature heat treatment is 110 to 200° C., more preferably 130 to 180° C. Herein, the means of the heat treatment is not particularly limited, and may be carried out by a heating means such as a hot plate, a hot air circulation path, an infrared ray furnace and the like.

### Curing the Heat-Treated Coating Film by Heat Treatment at a Temperature Higher Than That of the Low-Temperature Heat Treatment (Step 5)

Step 5 is a step of curing the coating film that is subjected to the low-temperature heat treatment in Step 4 by a high-temperature heat treatment.

The step of curing the alignment-treated coating film by heat treatment is a step that is carried out after the irradiation of light even in the method for preparing a liquid crystal alignment layer using a polymer for a liquid crystal aligning agent comprising a conventional polyamic acid or polyamic acid ester, and is distinguished from the heat treatment step of coating the liquid crystal aligning agent composition onto a substrate and then performing imidization of the liquid crystal aligning agent composition before irradiating the light or while irradiating the light.

In addition, the epoxy reaction of the compound having two or more epoxy groups in a molecule is carried out during the heat treatment, and thus, the alignment stabilization can be improved. Accordingly, the temperature for the heat treatment is a temperature at which the imidization of the polymer for a liquid crystal aligning agent and the epoxy reaction of the compound having two or more epoxy groups in a molecule are carried out, and is preferably higher than the temperature for the low temperature heat treatment of Step 4. Preferably, the temperature for the heat treatment is carried out at 200 to 250° C., more preferably at 210 to 240° C. Herein, the means of the heat treatment is not particularly limited and may be carried out by a heating means such as a hot plate, a hot air circulation path, an infrared ray furnace and the like.

### Liquid Crystal Alignment Layer

Further, the present invention may provide a liquid crystal alignment layer prepared in accordance with the method for preparing a liquid crystal alignment layer described above.

As described above, when the first polymer for a liquid crystal aligning agent and the second polymer for a liquid crystal aligning agent are mixed and used, a liquid crystal alignment layer having enhanced alignment properties and stability can be prepared. Furthermore, the alignment stability can be enhanced through the epoxy reaction of the compound having two or more epoxy groups in a molecule.

### Liquid Crystal Display Device

In addition, the present invention provides a liquid crystal display device comprising the liquid crystal alignment layer described above.

The liquid crystal alignment layer may be introduced into a liquid crystal cell by a known method, and likewise, the liquid crystal cell may be introduced into a liquid crystal display device by a known method. The liquid crystal alignment layer can be prepared by mixing the polymer essentially comprising the repeating unit represented by Chemical Formula 1 and the polymer comprising the repeating unit represented by Chemical Formula 4 and thus can implement excellent stability together with excellent physical properties. Accordingly, there may be provided a liquid crystal display device which can exhibit high reliability.

### Advantageous Effects

According to the present invention, by omitting the heat treatment process at a high temperature after coating the liquid crystal aligning agent composition onto a substrate and drying, directly irradiating the light to perform alignment treatment, followed by subjecting it to the low-temperature heat treatment and high-temperature heat treatment, not only the light irradiation energy can be reduced but also a liquid crystal alignment layer having excellent alignment properties and stability as well as excellent voltage holding ratio and electrical characteristics can be prepared by a simplified process.

### BRIEF DESCRIPTION OF DRAWINGS

FIG. 1 shows retardation changes according to the temperature for the low-temperature heat treatment in one Example and Comparative Example of the present invention.

### DETAILED DESCRIPTION OF THE EMBODIMENTS

Hereinafter, the present invention will be described in more detail by way of Examples. However, these Examples are given for illustrative purposes only, and the scope of the invention is not intended to be limited by these Examples.

### PREPARATION EXAMPLE 1

### Synthesis of Diamine

### Preparation Example 1-1) Synthesis of Diamine DA-1

Diamine DA-1 was synthesized according to the following reaction.

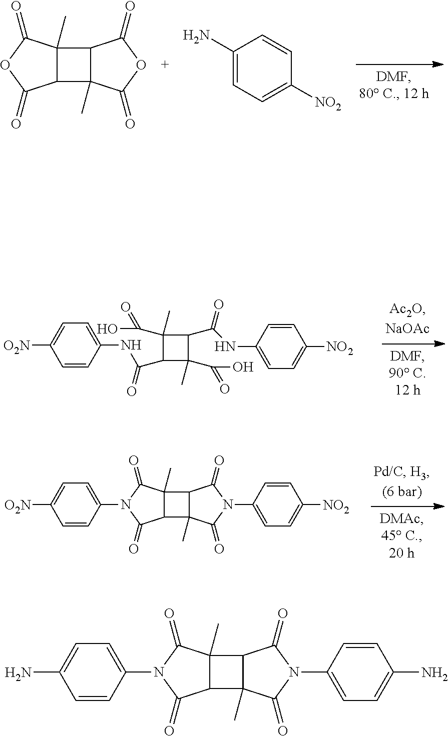 [SMILES: CC12C(=O)OC(=O)C1C1(C)C(=O)OC(=O)C21 ; Nc1ccc([N+](=O)[O-])cc1 ; CC1(C(=O)O)C(C(=O)Nc2ccc([N+](=O)[O-])cc2)C(C)(C(=O)O)C1C(=O)Nc1ccc([N+](=O)[O-])cc1 ; CC12C(=O)N(c3ccc([N+](=O)[O-])cc3)C(=O)C1C1(C)C(=O)N(c3ccc([N+](=O)[O-])cc3)C(=O)C21 ; CC12C(=O)N(c3ccc(N)cc3)C(=O)C1C1(C)C(=O)N(c3ccc(N)cc3)C(=O)C21]

Specifically, 1,3-dimethylcyclobuthane-1,2,3,4-tetracarboxylic dianhydride (DMCBDA) and 4-nitroaniline were dissolved in DMF (dimethylformamide) to prepare a mixture. Then, the mixture was reacted at about 80° C. for about 12 hours to prepare an auric acid. Subsequently, the amic acid was dissolved in DMF, and acetic anhydride and sodium acetate were added thereto to prepare a mixture. Then, the amic acid contained in the mixture was imidized at about 90° C. for about 4 hours. The thus-obtained imide was dissolved in DMAc (dimethylacetamide), and then Pd/C was added thereto to prepare a mixture. The mixture was reduced at 45° C. under hydrogen pressure of 6 bar for 20 minutes to prepare diamine DA-1.

### Preparation 1-2) Synthesis of Diamine DA-2

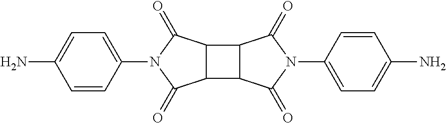 [SMILES: Nc1ccc(N2C(=O)C3C(C2=O)C2C(=O)N(c4ccc(N)cc4)C(=O)C32)cc1]

DA-2 having the structure above was prepared in the same manner as in Preparation Example 1, except that cyclobuthane-1,2,3,4-tetracarboxylic dianhydride (CBDA) was used instead of 1,3-dimethylcyclobuthane-1,2,3,4-tetracarboxylic dianhydride.

### PREPARATION EXAMPLE 2

### Preparation of Polymer for Liquid Crystal Aligning Agent

### Preparation Example 2-1) Preparation of Polymer for Liquid Crystal Aligning Agent P-1

(Step 1)

5.0 g (13.3 mmol) of DA-2 prepared in Preparation Example 1-2 was completely dissolved in 71.27 g of anhydrous N-methyl pyrrolidone (NMP). Then, 2.92 g (13.03 mmol) of 1,3-dimethylcyclobuthane-1,2,3,4-tetracarboxylic dianhydride was added to the solution under an ice bath and stirred at room temperature for 16 hours.

(Step 2)

The solution obtained in the Step 1 was poured into an excessive amount of distilled water to form a precipitate. Then, the formed precipitate was filtered and washed twice with distilled water and three times with methanol. The thus-obtained solid product was dried in a vacuum oven at 40° C. for 24 hours to obtain 6.9 g of the polymer for a liquid crystal aligning agent P-1.

As a result of confirming the molecular weight of P-1 through GPC, the number average molecular weight (Mn) was 15,500 g/mol, and the weight average molecular weight (Mw) was 31,000 g/mol. Further, the monomer structure of the polymer P-1 is determined by the equivalent ratio of the monomers used, and the ratio of the imine structure in the molecule was 50.5%, and the ratio of the amic acid structure was 49.5%.

### Preparation Example 2-2) Preparation of Polymer for Liquid Crystal Aligning Agent P-2

5.0 g of DA-1 prepared in Preparation Example 1-1 and 1.07 g of p-phenylenediamine (PDA) were completely dissolved in 103.8 g of NMP. Then, 2.12 g of cyclobutane-1,2,3,4-tetracarboxylic dianhydride (CBDA) and 3.35 g of 4.4′-oxydiphthalic dianhydride (OPDA) were added to the solution under an ice bath and stirred at room temperature for 16 hours. Thereafter, the polymer P-2 was prepared in the same manner as in Step 2 of Preparation Example 2-1.

As a result of confirming the molecular weight of P-2 through GPC, the number average molecular weight (Mn) was 18,000 g/mol, and the weight average molecular weight (Mw) was 35,000 g/mol. Further, as for the polymer P-2, the ratio of the imine structure in the molecule was 36.4%, and the ratio of the amic acid structure was 63.6%.

### Preparation Example 2-3) Preparation of Polymer for Liquid Crystal Aligning Agent P-3

6.0 g of DA-2 prepared in Preparation Example 1-2 and 1.37 g of 4,4′-oxydianiline (ODA) were completely dissolved in 110.5 g of NMP. Then, 3.47 g of DMCBDA and 1.44 g of pyromellitic dianhydride (PMDA) were added to the solution under an ice bath and stirred at room temperature for 16 hours. Thereafter, the polymer P-3 was prepared in the same manner as in the Step 2 of Preparation Example 2-1.

As a result of confirming the molecular weight of P-3 through GPC, the number average molecular weight (Mn) was 14,500 g/mol, and the weight average molecular weight (Mw) was 29,000 g/mol. Further, as for the polymer P-3, the ratio of the imine structure in the molecule was 41.9%, and the ratio the amic acid structure was 58.1%.

### Preparation Example 2-4) Preparation of Polymer for Liquid Crystal Aligning Agent Q-1

5.00 g of 4,4′-methylenedianiline and 5.05 g of 4,4′-oxydianiline were completely dissolved in 221.4 g of NMP. Then, 14.55 g of 4,4′-biphthalic anhydride was added to the solution under an ice bath and stirred at room temperature for 16 hours. Thereafter, the polymer Q-1 was prepared in the same manner as in the Step 2 of Preparation Example 2-1.

As a result of confirming the molecular weight of Q-1 through GPC, the number average molecular weight (Mn) was 25,000 g/mol, and the weight average molecular weight (Mw) was 40,000 g/mol.

### PREPARATION EXAMPLE 3

### Preparation of Liquid Crystal Aligning Agent Composition

### Preparation Examples 3-1

5 parts by weight of P-1 prepared in Preparation Example 2-1, 5 parts by weight of Q-1 prepared in Preparation Example 2-4 and 0.5 part by weight of (3′,4′-epoxycyclohexane)methyl 3,4-epoxycyclohexylcarboxylate (Celloxide 2021P manufactured by Daicel) were completely dissolved in a mixed solvent of NMP and n-butoxyethanol in a weight ratio of 8:2. Then, the resultant was subjected to pressure filtration with a filter made of poly(tetrafluoroethylene) having a pore size of 0.2 μm to prepare a liquid crystal aligning agent composition.

### Preparation Example 3-2

A liquid crystal aligning agent composition was prepared in the same manner as in Preparation Example 3-1, except that P-2 prepared in Preparation Example 2-2 was used instead of P-1 prepared in Preparation Example 2-1.

### Preparation Example 3-3

A liquid crystal aligning agent composition was prepared in the same manner as in Preparation Example 3-1, except that P-3 prepared in Preparation Example 2-3 was used instead of P-1 prepared in Preparation Example 2-1.

### Example 1

### Preparation of Liquid Crystal Alignment Layer and Liquid Crystal Cell

A liquid crystal cell was prepared by the following method using the liquid crystal aligning agent composition prepared above.

First, the liquid crystal aligning agent composition prepared in Preparation Example 3-1 was coated onto a substrate (lower plate) in which comb-shaped IPS mode ITO electrode patterns having a thickness of 60 nm, an electrode width of 3 μm and a spacing between the electrodes of 6 μm are formed on a rectangular glass substrate having a size of 2.5 cm×2.7 cm and to a glass substrate (upper plate) having no electrode pattern each using a spin coating method.

Then, the substrates to which the liquid crystal aligning agent composition was coated were placed on a hot plate at about 80° C. for one minute to evaporate the solvent. In order to align the thus-obtained coating film, the ultraviolet rays of 254 nm were irradiated with an intensity of 0.3 J/cm² using an exposure apparatus in which a linear polarizer was adhered to the coating film of each upper and lower plates.

Then, the coating film was placed on a hot plate at 130° C. for 500 seconds, thereby subjecting it to a low-temperature heat treatment. Thereafter, the coating film was calcinated (cured) in an oven at about 230° C. for 20 minutes to obtain a coating film having a thickness of 0.1 μm. Then, a sealing agent impregnated with a ball spacer having a size of 3 μm was applied to the edge of the upper plate except the liquid crystal injection hole. Subsequently, the alignment layers formed on the upper plate and the lower plate were aligned such that they face each other and that the alignment directions are aligned with each other, and then the upper and lower plates were bonded together and the sealing agent was cured to prepare an empty space. Then, a liquid crystal was injected into the empty cells to produce an IPS mode liquid crystal cell.

### Examples 2 to 6

Each liquid crystal cell was prepared in the same manner as in Example 1, except that the temperature for the low-temperature heat treatment was raised to 160° C. (Example 2), 180° C. (Example 3), 200° C. (Example 4), 210° C. (Example 5) and 220° C. (Example 6), respectively.

### Comparative Examples 1 and 2

A liquid crystal cell was prepared in the same manner as in Example 1, except that the low-temperature heat treatment was omitted (Comparative Example 1). Further, a liquid crystal cell was prepared in the same manner as in Example 1, except that the low-temperature heat treatment was omitted and the calcination (curing) temperature was set to 240° C.

### Experimental Example

The characteristics of the liquid crystal cells prepared in Examples and Comparative Examples were evaluated as follows.

### a. Measurement of Retardation (R)

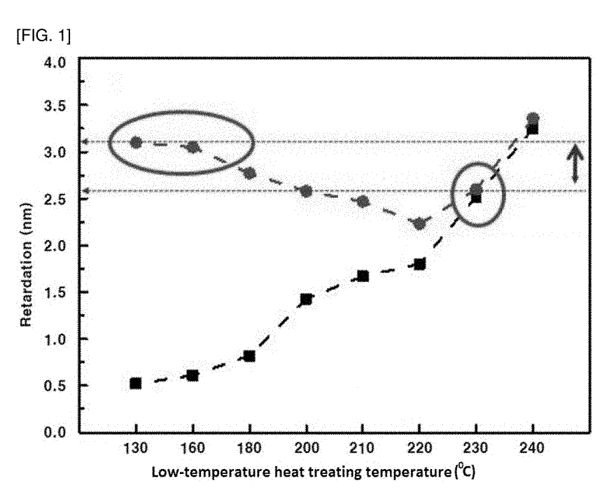

In Examples, the retardation was measured after carrying out the low-temperature heat treatment process, and the retardation was measured after carrying out the high-temperature heat treatment process. In the case of Comparative Examples, the retardation was measured after carrying out the high-temperature heat treatment process. Each retardation was measured using AxoStep manufactured by Axomertics, Inc., and the results are shown in FIG. 1.

As shown in FIG. 1, the increase in the retardation was significant when the low-temperature heat treatment was carried out at 130 to 130° C. and then the high-temperature heat treatment was carried out. Particularly, when the low-temperature heat treatment was carried out at 130° C., followed by carrying out the high-temperature heat treatment, the retardation value was about 25% higher than that of Comparative Example 1.

### b. Measurement of AC Residual Image

The AC residual image was measured using the liquid crystal cell of Example 1 and the liquid crystal cell of Comparative Example 1.

Specifically, polarizing plates were adhered to the upper plate and lower plate of the liquid crystal cell so as to be perpendicular to each other. The liquid crystal cell to which the polarizing plates were adhered was adhered onto a backlight of 7,000 cd/m², and the brightness in a black mode was measured using a PR-880 equipment which is a device for measuring the brightness. Then, the liquid crystal cell was driven at room temperature for 24 hours with an AC voltage of 5V. Thereafter, the brightness in a black mode was measured in the same manner as described above in a state in which the voltage of the liquid crystal cell was turned off. The difference between the initial brightness (L₀) measured before driving the liquid crystal cell and the final brightness (L₁) measured after driving the liquid crystal cell was divided by the value of the initial brightness (L₀) and multiplied by 100, thereby calculating the brightness fluctuation rate. As the calculated brightness fluctuation rate is closer to 0%, it means that the alignment stability is excellent.

As a result of the measurement, the liquid crystal cell of Example 1 had a brightness fluctuation rate of 2.29% (±1.32%), while the liquid crystal cell of Comparative Example 1 had a brightness fluctuation rate of 5.08% (±1.26%).

### c. Evaluation of VHR (Voltage Holding Ratio) High-Temperature Long-Term Reliability

Using the liquid crystal cell of Example 1 and the liquid crystal cell of Comparative Example 1, the VHR (voltage holding ratio) high-temperature long-term reliability was evaluated.

Specifically, the voltage holding ratio (VHR) was measured, using a TOYO 6254 equipment, before applying harsh conditions (VHR_{Initial}), and then measured once again after allowing the liquid crystal cells to stand under harsh conditions of 5V, 60 Hz, 60° C. for 120 hours (VHR_{Stress}). The measurement results thereof were calculated by the following Equation 1.

VHR high-temperature long-term reliability=(VHR_{Initial}−VHR_{Stress})/VHR_{Initial} [Equation 1]

In this regard, the VHR high-temperature long-term reliability is superior as the value thereof decreases, and the VHR high-temperature long-term reliability for the liquid crystal cell of Example 1 was 13%, while the VHR high-temperature long-term reliability for the liquid crystal cell of Comparative Example 1 was 25%. Therefore, it can be confirmed that when the liquid crystal cells are prepared by the preparation method according to the present invention, the VHR high-temperature long-term reliability is superior.

1. A method for preparing a liquid crystal alignment layer comprising the steps of:
1) coating a liquid crystal aligning agent composition onto a substrate to form a coating film;
2) drying the coating film;
3) irradiating the coating film with light immediately after the drying step to perform alignment treatment;
4) subjecting the alignment-treated coating film to a low-temperature heat treatment at 200° C. or lower; and
5) curing the heat-treated coating film by heat treatment at a temperature higher than that of the low-temperature heat treatment,
wherein the liquid crystal aligning agent composition comprises i) a first polymer for a liquid crystal aligning agent comprising two or more repeating units selected from the group consisting of a repeating unit represented by Chemical Formula 1 below, a repeating unit represented by Chemical Formula 2 below and a repeating unit represented by Chemical Formula 3 below, wherein the repeating unit represented by Chemical Formula 1 below is contained in an amount of 5 to 74 mol % relative to the total repeating units represented by Chemical Formulae 1 to 3 below, ii) a second polymer for a liquid crystal aligning agent comprising a repeating unit represented by Chemical Formula 4 below, and iii) a compound having two or more epoxy groups in a molecule: 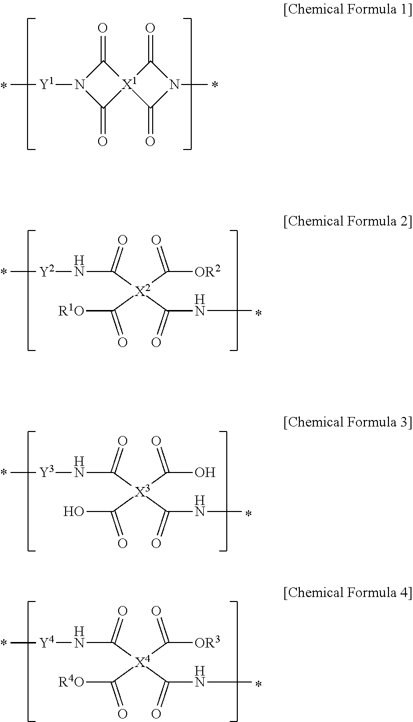
in Chemical Formulae 1 to 4,
R¹ and R² are each independently hydrogen, or C₁₋₁₀ alkyl, with the proviso that R¹ and R² cannot both be hydrogen,
R³ and R⁴ are each independently hydrogen, or C₁₋₁₀ alkyl, and
X¹ is a tetravalent organic group represented by Chemical Formula 5 below, 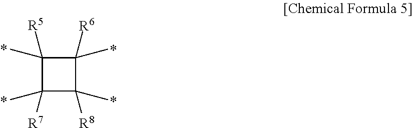
in Chemical Formula 5,
R⁵ to R⁸ are each independently hydrogen, or C₁₋₆ alkyl,
X², X³ and X⁴ are each independently a tetravalent organic group derived from a hydrocarbon having 4 to 20 carbon atoms, or a tetravalent organic group in which at least one hydrogen in the tetravalent organic group is substituted with a halogen or in which at least one —CH₂— is replaced by —O—, —CO—, —S—, —SO—, —SO₂— or —CONH— such that the oxygen or sulfur atoms are not directly linked, and
Y¹, Y², Y₃ and Y⁴ are each independently a divalent organic group represented by Chemical Formula 6 below, 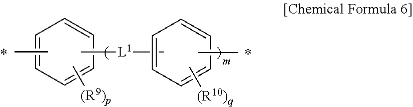
in Chemical Formula 6,
R⁹ and R¹⁰ are each independently halogen, cyano, C₁₋₁₀ alkyl, C₂₋₁₀ alkenyl, C₁₋₁₀ alkoxy, C₁₋₁₀ fluoroalkyl, or C₁₋₁₀ fluoroalkoxy,
p and q are each independently an integer between 0 and 4,
L¹ is a single bond, —O—, —CO—, —S—, —SO₂—, —C(CH₃)₂—, —C(CF₃)₂—, —CONH—, —COO—, —(CH₂)_{z}—, —O(CH₂)_{z}O—, —O(CH₂)_{z}—, —OCH₂—C(CH₃)₂—CH₂O—, —COO—(CH₂)_{z}—OCO—, or —OCO—(CH₂)_{z}—COO—,
wherein z is an integer between 1 and 10, and
m is an integer between 0 and 3.

2. The method for preparing a liquid crystal alignment layer of claim 1,
wherein the X², X³ and X⁴ are each independently a tetravalent organic group described in Chemical Formula 7 below: 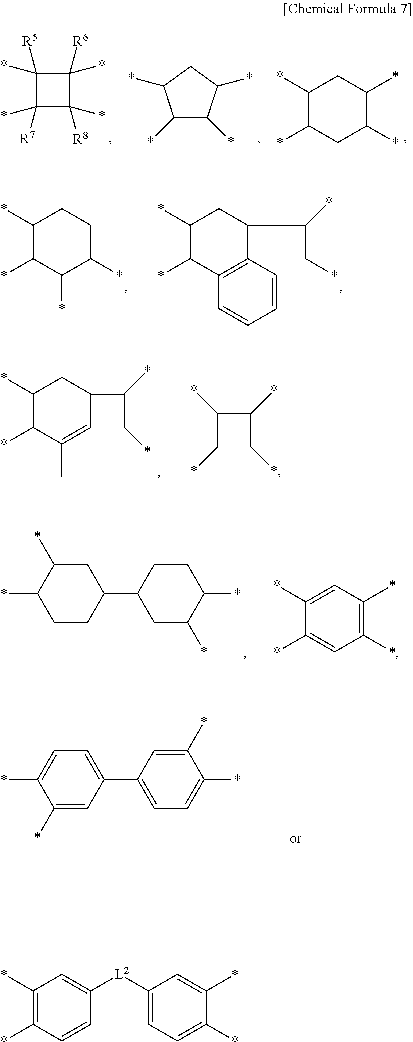
in Chemical Formula 7,
R⁵ to R⁸ are each independently hydrogen, or C₁₋₆ alkyl,
L² is a single bond, —O—, —CO—, —S—, —C(CH₃)₂—, —C(CF₃)₂—, —CONH—, —COO—, —(CH₂)_{z}—, —O(CH₂)_{z}O—, or —COO—(CH₂)_{z}—OCO—,
wherein z is an integer between 1 to 10.

3. The method for preparing a liquid crystal alignment layer of claim 1,
wherein the compound having two or more epoxy groups in a molecule has a molecular weight of 100 to 10,000.

4. The method for preparing a liquid crystal alignment layer of claim 1,
wherein the compound having two or more epoxy groups in a molecule is a cycloaliphatic-based epoxy, bisphenol-based epoxy, or a novolak-based epoxy.

5. The method for preparing a liquid crystal alignment layer of claim 1,
wherein the compound having two or more epoxy groups in a molecule is contained in an amount of 0.1 to 30% by weight based on the weight of the polymer for a liquid crystal aligning agent.

6. The method for preparing a liquid crystal alignment layer of claim 1,
wherein the weight ratio of the first polymer for a liquid crystal aligning agent to the second polymer for a liquid crystal aligning agent is 1:9 to 9:1.

7. The method for preparing a liquid crystal alignment layer of claim 1,
wherein the liquid crystal aligning agent composition is a composition in which the first polymer for a liquid crystal aligning agent, the second polymer for a liquid crystal aligning agent and the compound having two or more epoxy groups in a molecule are dissolved or dispersed in an organic solvent.

8. The method for preparing a liquid crystal alignment layer of claim 1,
wherein the drying of Step 2 is carried out at 50 to 130° C.

9. The method for preparing a liquid crystal alignment layer of claim 1,
wherein the alignment treatment of Step 3 is carried out by irradiating polarized ultraviolet rays having a wavelength of 150 to 450 nm.

10. The method for preparing a liquid crystal alignment layer of claim 1,
wherein the low-temperature heat treatment of Step 4 is carried out at 110 to 200° C.

11. The method for preparing a liquid crystal alignment layer of claim 1,
wherein the heat treatment of Step 5 is carried out at 200 to 250° C.

12. A liquid crystal alignment layer prepared according to claim 1.

13. A liquid crystal display device comprising the liquid crystal alignment layer of claim 12.

14. A method for preparing a liquid crystal alignment layer comprising the steps of:
1) coating a liquid crystal aligning agent composition onto a substrate to form a coating film;
2) drying the coating film;
3) irradiating the coating film with light immediately after the drying step to perform alignment treatment;
4) subjecting the alignment-treated coating film to a low-temperature heat treatment at 200° C. or lower; and
5) curing the heat-treated coating film by heat treatment at a temperature higher than that of the low-temperature heat treatment,
wherein the liquid crystal aligning agent composition comprises a polyimide precursor and a compound having two or more epoxy groups in a molecule.
